(19) United States
(12) Patent Application Publication
(10) Pub. No.: US 2024/0377596 A1
(43) Pub. Date: Nov. 14, 2024

(54) WAVEGUIDE LIGHT EMITTING MODULE

(71) Applicants: Yakov Soskind, Plainsboro, NJ (US); Michael Soskind, Plainsboro, NJ (US); Rose Soskind, Plainsboro, NJ (US)

(72) Inventors: Yakov Soskind, Plainsboro, NJ (US); Michael Soskind, Plainsboro, NJ (US); Rose Soskind, Plainsboro, NJ (US)

(21) Appl. No.: 18/657,457

(22) Filed: May 7, 2024

Related U.S. Application Data
(63) Continuation-in-part of application No. 18/144,304, filed on May 8, 2023.

(51) Int. Cl. G02B 6/42

(52) U.S. Cl. CPC G02B 6/4215

(57) ABSTRACT

A device for forming spatial light distributions based on a waveguiding component containing an array of diffractive regions is described. The waveguide-based light emitting module has reduced size and weight as compared to light emitting modules with traditional optical elements. Compared to traditional light emitting modules, the exit aperture of the waveguide light emitting module is composed of sub-aperture regions that out-couple light and direct the emitted radiation at different angles.

### CROSS-REFERENCE TO RELATED APPLICATION

This application is a continuation-in-part of U.S. Ser. No. 18/144,304, filed May 8, 2023 entitled “Waveguide-Based Light Field Camera”, the contents of which are incorporated herein by reference.

### FIELD OF THE INVENTION

The present invention relates to the field of light emitting modules that produce spatial light distributions. More specifically, the invention relates to waveguide light emitting modules with compact spatial dimensions.

### BACKGROUND OF THE INVENTION

Traditional light emitting modules that produce spatial light distributions are composed of an assembly of light emitting sources and an assembly of optical components, such as lenses, mirrors, or their combinations. Edge-emitting lasers, vertical cavity surface emitting lasers (VCSELs) or light-emitting diodes (LEDs) are examples of light emitting devices. Individual light emitters and arrays of light emitters can be used within the light emitting modules. Light emitting modules can be designed to produce either diffuse or structured light distributions and are employed in a variety of sensing systems. Traditional light emitting modules are relatively bulky, making them challenging to integrate into sensor systems with strict weight and spatial constraints.

### SUMMARY OF THE INVENTION

In view of the foregoing, one object of the present invention is to provide light emitting modules with reduced size and weight.

Another object of the present invention is to provide light emitting modules that can be fabricated in a cost-effective and scalable manner.

Still another object of the present invention is to provide light emitting modules that can provide emitted light fields with independently controlled and non-uniformly spaced angular distributions that are not limited by continuously varying shapes of traditional lens surfaces.

To achieve the desired goals, the light emitting module employs waveguiding components containing arrays of diffractive phase regions. The light emitting module with waveguide structures has reduced size and weight compared to light emitting modules employing traditional optical components with refractive and/or reflective surfaces, making it a viable alternative for integration into products with strict weight and size constraints.

Waveguiding components can be comprised of a plane-parallel plate made of optically transparent material, and usually contain light in-coupling regions where the light enters the waveguide, waveguiding regions where the in-coupled light experiences waveguiding propagation within the plate, and out-coupling regions where the waveguided light exits the waveguiding component. To further reduce the overall size and improve manufacturability, the in-coupling and the out-coupling regions are often made as diffractive structures. Different types of diffractive structures can be employed within the in-coupling and out-coupling regions, such as linear gratings, 2D or 3D meta-surfaces containing sub-wavelength surface-relief structures, or holographic structures composed of localized sub-wavelength refractive index modulations.

To achieve the waveguided propagation of the in-coupled fields within the waveguiding component, the angles of the in-coupled light within the plane-parallel plate should exceed the critical angle at the waveguide planar interfaces, resulting in the formation of evanescent orders. In addition, angles of the diffracted in-coupled light fields need to satisfy the propagation condition for the working diffraction order (see for example Y. Soskind, “Field Guide to Diffractive Optics”, SPIE Press, 2011, page 51). Therefore, the waveguided propagation can be expressed as:

$$\frac{1}{{n}_{s}} < \vert \frac{1}{{n}_{s}} ( sin ( {θ}_{i} ) + \frac{λ}{{d}_{g}} ) \vert < 1 \qquad ( 1 )$$

where θᵢ is the incident angle of light, λ is the light wavelength, d_{g} is the grating's line spacing, and ηₛ is the waveguiding component substrate's refractive index. It is also assumed in equation (1) that the order of diffraction is m=1, and the index of refraction in air is η_{Air}≈1.

Objectives of the present invention are achieved in accordance with the following implementation techniques and design examples, as will be explained in detail in the following illustrative embodiments.

The features of the present invention, including the construction and operational details of the illustrative embodiments, will be described in reference to the accompanying drawings.

### BRIEF DESCRIPTION OF THE DRAWINGS

FIG. 1 presents a side view of the waveguide-based light emitting module in accordance with the present invention.

FIG. 2 presents the side view of the light emitted by an array of sources and propagating through a diffractive flat lens onto the exit aperture of the lens.

FIG. 3 shows a close-up view of the light emitted by the individual sources of the emitter array.

FIG. 4 presents a top view of the light emitting module waveguiding component in accordance with the present invention.

FIG. 5 shows three-dimensional geometry defining diffraction of the waveguided light by the in-coupling grating within the in-coupling region.

FIG. 6 shows the top view geometry defining the waveguiding component containing an in-coupling region and one of the out-coupling sub-regions.

FIG. 7 presents the first layout of the out-coupling sub-regions of the light emitting module waveguide.

FIG. 8 presents the second layout of the out-coupling sub-regions of the light emitting module waveguide.

FIG. 9 presents the third layout of the out-coupling sub-regions of the light emitting module waveguide.

FIG. 10 presents spatial phase distribution of a diffractive lens centered over the out-coupling sub-region.

FIG. 11 presents spatial phase distribution of a diffractive grating placed over the out-coupling sub-region.

FIG. 12 presents spatial phase distribution of a diffractive lens offset from the center of the out-coupling sub-region.

FIG. 13 presents spatial phase distribution of a second diffractive grating placed over the out-coupling sub-region.

FIG. 14 presents spatial phase distribution of a diffractive lens with different offset from the center of the out-coupling sub-region

FIG. 15 shows the side view of the waveguide-based light emitting module in accordance with the first example.

FIG. 16 shows the side view of the waveguide-based light emitting module in accordance with the second example.

FIG. 17 presents a side view of an alternative waveguide-based light emitting module in accordance with the present invention.

FIG. 18 presents a side view of an alternative waveguide-based light emitting module in accordance with the present invention.

FIG. 19 presents a side view of an alternative waveguide-based light emitting module in accordance with the present invention.

FIG. 20 presents the side view of light emitted by an array of sources and propagating at an angle through a diffractive flat lens onto the exit aperture of the lens.

FIG. 21 presents a side view of an alternative waveguide-based light emitting module in accordance with the present invention.

FIG. 22 presents a side view of an alternative waveguide-based light emitting module in accordance with the present invention.

FIG. 23 presents a side view of an alternative waveguide-based light emitting module in accordance with the present invention.

FIG. 24 presents a side view of an alternative waveguide-based light emitting module demonstrating beam steering by laterally shifting the flat lens with respect to the light emitter.

FIG. 25 presents a side view of an alternative waveguide-based light emitting module demonstrating beam steering of divergent output radiation by laterally and axially shifting the flat lens with respect to the light emitter.

### DETAILED DESCRIPTION

The present invention is further described in detail in the form of the specific embodiment. However, the present invention is not limited to only the specific embodiments described herein, and can be employed with a broad range of modifications to the disclosed embodiments. For example, both arrays of emitters and single emitters can be employed as sources within the light emitting modules of the present invention. The waveguide-based light emitting module of the present invention can be used to produce either structured or homogeneously distributed illumination patterns. While in the following embodiments the in-coupled light is directed into a single direction, the in-coupling region can be also designed to split the input light into several in-coupled directions that will experience wave-guiding propagation.

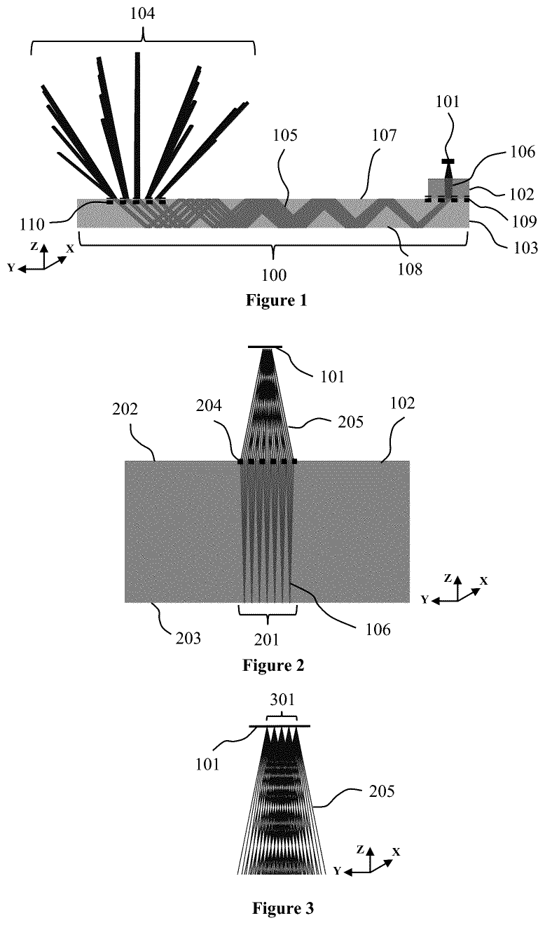

FIG. 1 presents a side view of the light emitting module perpendicular to the waveguide propagation direction in accordance with the present invention. The light emitting module 100 contains an array of emitters 101, a planar lens 102, and a waveguiding component 103 with planar interfaces defined by surfaces 107 and 108. The lens 102 and the waveguiding component 103 are placed in proximity to each other. The waveguiding component contains an in-coupling region 109 and an out-coupling region 110 fabricated onto the surface 107. The in-coupling region 109 and the out-coupling region 110 can incorporate different diffractive structures, such as meta-surfaces, geometrical phase surfaces, volume holograms, multi-step binary surfaces, etc. Diffractive structures can be fabricated using a variety of techniques, such as projection lithography, nano-imprint, holographic recording, etc. FIG. 1 also shows the waveguided light 105 within component 103, and the output light beams 104 emitted in multiple directions from the out-coupling region 110 of the waveguiding component 103.

The light from emitter array 101 is directed onto a flat diffractive lens 102 that collimates the emitted light 106 and directs it towards the waveguide in-coupling region 109. Collimated beams from the individual emitters are incident onto the in-coupling structure 109 at different angles. The angular difference Δφ between the incident collimated beams depends on the lateral spacing d between the emitters within the array and the focal length ƒ of the lens 102, and can be estimated as:

$$Δφ = {tan}^{- 1} ( \frac{d}{f} ) \qquad ( 1 )$$

The collimated light in-coupled into the waveguiding component 103 through the diffractive in-coupling region 109 at angles exceeding the critical angle of total internal reflection (TIR) is converted into waveguided modes 105 that travel within the waveguiding component 103 while experiencing TIRs at the planar interfaces 107 and 108. As the waveguided light 105 reaches the out-coupling region 110, it is extracted from the waveguide and directed by different sub-regions of the out-coupling region 110 in different output directions 104.

FIG. 1 shows an example of the waveguided light experiencing 9 instances of TIR on the planar interfaces of the waveguiding component prior to reaching the out-coupling region 110. The number of TIRs within the waveguiding component can differ and will depend on the desired distance between the in-coupling and out-coupling regions. When the in-coupling and out-coupling regions are located on the same side of the waveguide, then the number of TIRs within the waveguiding component experienced by the propagating light prior to reaching the out-coupling region will be odd. When the in-coupling and out-coupling regions are located on opposite sides of the waveguiding component, then the number of TIRs within the waveguide experienced by the propagating light prior to reaching the out-coupling region will be even. After reaching the out-coupling region 110, the waveguided light is outcoupled from the waveguiding component 103 at different angles 104.

The in-coupling region 109 serves as the entrance aperture of the waveguiding component 103, and is comprised of diffractive structures. The in-coupled light 105 is directed onto the out-coupling region 110, where it is diffracted out of the waveguide by individual sub-regions of the out-coupling structure 110. The out-coupling region 110 serves as the exit aperture of the emitting module and is comprised of multiple out-coupling sub-regions with different diffractive properties that diffract output light in different directions 104. The individual sub-regions of the structure 110 out-couple incident light to the specific angular directions defined by the diffractive properties of the specific sub-regions.

FIG. 2 shows light propagation from array of emitters 101 first introduced in FIG. 1 through the flat lens 102 onto the lens exit aperture 201. The lens 102, also first introduce in FIG. 1, consists of a block of an optical material transparent within the spectral region of the waveguide-based light emitting module, such as optical glass, silicon, or fused silica. The lens 102 has two plane parallel optical surfaces 202 and 203. Alternative lens designs may contain diffractive regions fabricated on both lens surfaces 202 and 203, or solely on one of the lens surfaces. Lens 102 shown in FIG. 2 has a single diffractive structure 204 placed on surface 202 facing the emitter array 101. Emitted diverging light 205 from the array of emitters 101 is collimated by the diffractive structure 204. The collimated light 106 is directed onto the lens exit aperture 201 located on lens surface 203. Diffractive region 204 can be made as a diffractive phase structure, such as a meta-surface, geometrical phase surface, volume hologram, multi-step binary surface, etc.

Lenses with planar interfaces are well suited for integration with waveguiding components having planar surfaces. The lens optical power is produced by diffractive regions fabricated either on one or both planar surfaces of the lens. Diffractive regions of the planar lens can be comprised of different types of structures, including surface relief or encapsulated diffractive stair-case or blazed structures, surface relief or encapsulated sub-wavelength meta-optics structures, or volume Bragg gratings and holograms comprised of localized sub-wavelength refractive index modulations of the optical medium. It should be noted that lens components with at least one non-planar optical interface, such as spherical or aspherical refractive surface, can also be used to direct emitted light onto the in-coupling region of the waveguide.

FIG. 3 presents an enlarged view of the divergent light 205 emitted from the individual emitters 301 composing the emitter array 101. The emitted divergent light 205 is directed towards the diffractive collimating lens.

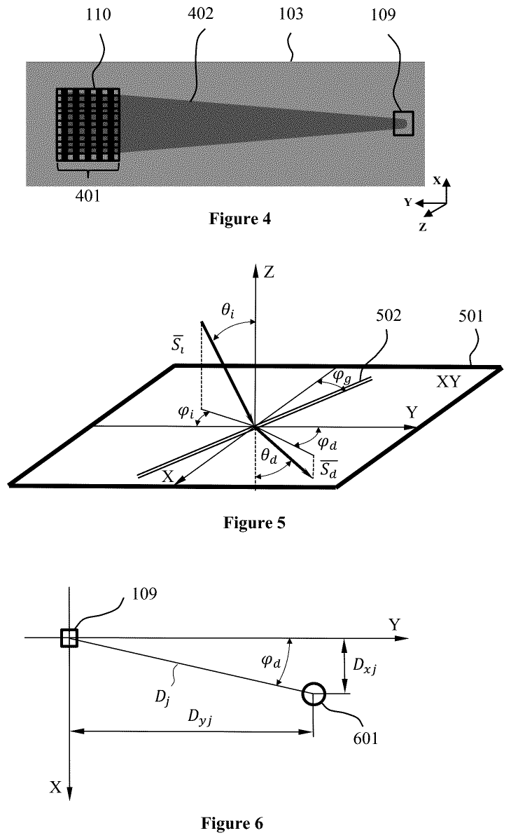

FIG. 4 presents a top view of the waveguiding component 103 containing the in-coupling region 109 and the out-coupling region 110, first introduced in FIG. 1. While the in-coupling region 109 is shown as having a square-shaped outline, it can also be made as a polygonal structure of different shape, as a circle, or as an ellipse. To achieve efficient in-coupling, the size of the in-coupling region 109 is made at least the size of the output aperture the planar lens. The out-coupling region 110 is composed of smaller subregions with different diffractive properties. The individual sub-regions can be made of different shapes and sizes. The sub-regions can be arranged within the out-coupling region in a randomized, irregular manner, or as arrays of sub-regions arranged in rows or columns, where the rows and columns can be placed next to each other or separated with spaces. Individual sub-regions contain diffractive structures with different optical properties, such as gratings, lenses, beam-splitters, and their combinations. The out-coupling subregions of the out-coupling region 110 are shown schematically as vertical columns 401. FIG. 4 also shows the footprint of the waveguided light 402 within the waveguiding component 103 as it propagates from the in-coupling region 109 to the out-coupling region 110.

Designs of the gratings within the in-coupling region and the diffractive structures within the individual out-coupling sub-regions are based on their diffractive properties that depend on their phase distributions. The phase distributions are defined by pitch and azimuthal orientation of the grating ridges or spatial arrangements of sub-wavelength meta-atoms, including their shapes and sizes. The phase distributions need to take into account several parameters, including direction of the incident light, diffraction of the incident light on the in-coupling grating structures into the waveguide, propagation direction and number of TIR interactions of the in-coupled light prior to reaching the out-coupling sub-regions, and diffraction of the waveguided light on the individual out-coupling sub-regions with different the shapes, sizes and diffraction phase distributions.

FIG. 5 schematically shows the three-dimensional geometry defining diffraction of light on the diffractive structure with boundary 501 representing the in-coupling region of the waveguiding structure. FIG. 5 shows light incident onto the diffractive structure from medium with lower refractive index ηᵢ, such as air, into a denser medium with higher refractive index η_{d}, such as glass, representative of in-coupling into the waveguide through the in-coupling grating of the in-coupling region. In that case ηᵢ<η_{d}, and the incident angle θᵢ is smaller than the in-coupled diffracted angle θ_{d}, i.e. θᵢ<θ_{d}. Geometry definition in FIG. 5 is also applicable to define out-coupling of the waveguided light from one of the out-coupling sub-regions. For the out-coupling of the waveguided light from the out-coupling sub-regions, the light incident onto the diffractive sub-region will be travelling from the denser medium with higher refractive index ηᵢ, such as glass, into a medium with lower refractive index, such as air η_{d}, i.e. ηᵢ>η_{d}. And the incident angle θᵢ within the waveguide will be larger than the out-coupled angle θ_{d} into the air, i.e. θᵢ>θ_{d}.

Propagation directions of the incident light and the diffracted light are defined by respective unit vectors S̅ₗ̅ and S̅_̅{̅d̅}̅ in the Cartesian coordinate system. In the case of FIG. 5, the unit vectors are oriented in the case of in-coupling with refractive index relation ηᵢ<η_{d}. The X- and Y-axes define a plane XY, schematically shown as a dashed area, that contains the in-coupling region. The grating lines 502 in FIG. 5 are oriented at an angle φ_{g} with respect to the X-axis of the coordinate system.

The unit vector S̅ₗ̅ is composed of three directional components Sᵢₓ, S_{iy}, and S_{iz} along the respective X-axis, Y-axis and Z-axis unit vectors l̅, j̅, and k̅:

$$\overline{{S}_{ι}} = {S}_{i x} \overline{ι} + {S}_{iy} \overline{} + {S}_{i z} \overline{k} \qquad ( 3 )$$

The individual components of the unit vector S̅ₗ̅ are functions of the azimuth φᵢ and elevation θᵢ angles shown in FIG. 5:

$${S}_{i x} = sin ( {θ}_{i} ) sin ( {φ}_{i} ) \qquad ( 4 )$$

$${S}_{i y} = sin ( {θ}_{i} ) cos ( {φ}_{i} ) \qquad ( 5 )$$

$${S}_{i z} = cos ( {θ}_{i} ) \qquad ( 6 )$$

Direction of the in-coupled light diffracted by the grating is defined by a unit vector S̅_̅{̅d̅}̅:

$$\overline{{S}_{d}} = {S}_{d x} \overline{ι} + {S}_{dv} \overline{} + {S}_{d z} \overline{k} \qquad ( 7 )$$

The individual components of the unit vector S̅_̅{̅d̅}̅ are functions of the diffracted azimuth φ_{d} and elevation θ_{d} angles:

$${S}_{dx} = sin ( {θ}_{d} ) sin ( {φ}_{d} ) \qquad ( 8 )$$

$${S}_{dy} = sin ( {θ}_{d} ) cos ( {φ}_{d} ) \qquad ( 9 )$$

$${S}_{dz} = cos ( {θ}_{d} ) \qquad ( 10 )$$

By definition, components of the unit vectors S̅ₗ̅ and S̅_̅{̅d̅}̅ satisfy the following equations:

$${( {S}_{ix} )}^{2} + {( {S}_{iy} )}^{2} + {( {S}_{iz} )}^{2} = 1 \qquad ( 11 )$$

$${( {S}_{dx} )}^{2} + {( {S}_{dy} )}^{2} + {( {S}_{dz} )}^{2} = 1 \qquad ( 12 )$$

Components of the in-coupled unit vector can be found based on the following two equations that account for diffraction on the in-coupling grating structure, where n is the refractive index of the waveguide material:

$${n}_{d} sin ( {θ}_{d} ) sin ( {φ}_{d} ) = {n}_{d} sin ( {θ}_{i} ) sin ( {φ}_{i} + {φ}_{g} ) \qquad ( 13 )$$

$${n}_{d} sin ( {θ}_{d} ) cos ( {φ}_{d} ) = {n}_{i} sin ( {θ}_{i} ) cos ( {φ}_{i} + {φ}_{g} ) + \frac{m λ}{{d}_{j}} \qquad ( 14 )$$

Parameter m in equation (14) denotes the order of diffraction, λ is the wavelength of the incident light, and dⱼ is the line spacing of the grating structure of the j-th in-coupling region. In many cases, the gratings are designed to work in the first order of diffraction, so that m=1.

The relative positions of the individual out-coupling sub-regions of the waveguiding component are designed to capture or intercept the light from selected emitters of the emitter array. The individual out-coupling sub-regions subsequently diffract the captured or intercepted light into selected angular directions. The size and location of an individual sub-region can be chosen so that it captures or intercepts at least a fraction of light from a particular light emitter. Diffraction properties of the individual out-coupling sub-regions are defined to out-couple at least a fraction of the light captured or intercepted by the individual out-coupling sub-region.

FIG. 6 schematically shows the top view of the waveguiding component containing an in-coupling region 109 and one of the out-coupling sub-regions denoted by an integer j and having boundary 601. Following diffraction on the grating structure, the in-coupled light travels a distance Dⱼ along the waveguiding component from the in-coupling region to the center of the out-coupling sub-region. The specific distances between the in-coupling region and the individual out-coupling sub-regions of the waveguide depend on their respective locations within the out-coupling region and the number of TIRs experienced by the in-coupled light prior to reaching the specific out-coupling sub-region. When the in-coupling region and the out-coupling sub-regions are located on the same surface of the wave-guiding component, the in-coupled light will undergo an odd integer number of TIRs prior to reaching the out-coupling region. When the in-coupling region and the out-coupling sub-regions are located on opposite surfaces of the waveguide, the in-coupled light will undergo an even number of TIRs. These conditions impose additional constraints on the orientations and line spacings of the gratings within the specific out-coupling sub-regions. FIG. 6 illustrates the geometrical relations between an in-coupling region 109, schematically shown as a square, and a circular-shaped out-coupling sub-region 601, schematically shown as a circle. The in-coupling region 109 is connected to the out-coupling sub-region 601 by a line Dⱼ representing the distance between the two regions along the waveguide surface parallel to the XY plane. FIG. 6 also shows the respective X-axis and Y-axis lateral distances Dₓⱼ and D_{yj} between the centers of the in-coupling region and the out-coupling sub-region. The distance Dⱼ can be found as:

$${D}_{j} = \sqrt{{( {D}_{xj} )}^{2} + {( {D}_{yj} )}^{2}} \qquad ( 15 )$$

Following diffraction on the in-coupling grating structure, the in-coupled light will propagate towards the center of the out-coupling sub-region within a plane defined by the direction of the in-coupled light S̅_̅{̅d̅}̅ and the normal to the waveguide surface defined by the Z-axis vector k̅. The in-coupled light will encounter multiple TIRs.

Between each consecutive TIR, the in-coupled light will advance towards the center of the out-coupling region by an incremental distance Δ_{Dj}:

$$Δ {D}_{j} = \frac{T}{tan ( {θ}_{dj} )} \qquad ( 16 )$$

where T is the waveguide thickness, defined as the distance between the planar interfaces of the waveguiding component, and θ_{dj} is the elevation angle of the light field after diffraction on the j-th out-coupling sub-region.

The distance Dⱼ contains an integer number N of TIR steps during propagation:

$${D}_{j} = N Δ {D}_{j} \qquad ( 17 )$$

For a given direction of the incident light \vec{Sₗ}, the distance Dⱼ between the in-coupling region and the out-coupling sub-region, thickness T and refractive index η of the waveguide, operating wavelength λ, and required number of TIRs within the waveguide N, the equations (3) through (17) can be numerically solved to yield the nominal line spacings dⱼ of the out-coupling gratings and their azimuthal orientations φ_{g}.

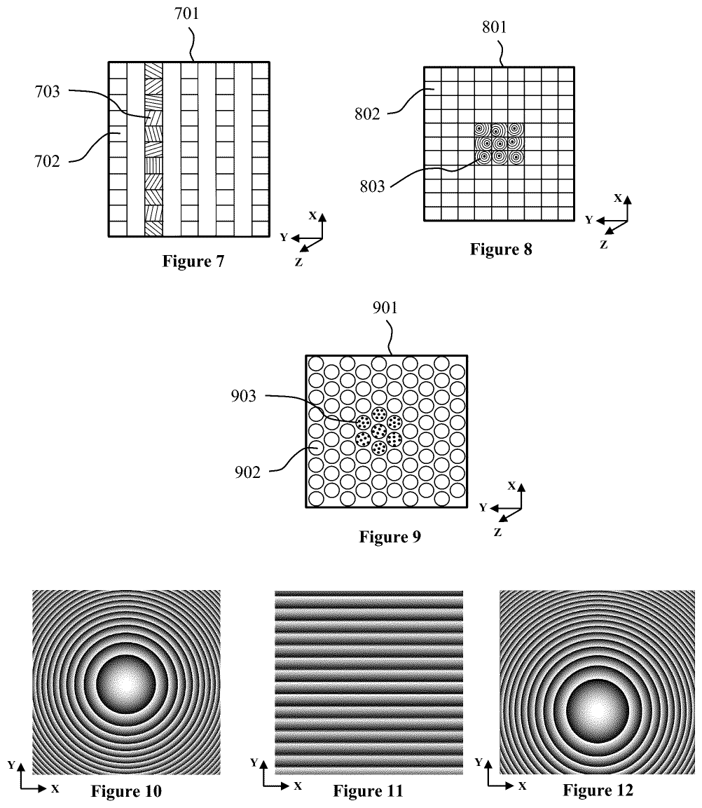

FIGS. 7 through 9 present different layouts of the out-coupling regions of the waveguiding component. The out-coupling regions are composed of several out-coupling sub-regions of different shapes and sizes, such as circles, hexagons, triangles, and their combinations. While the out-coupling regions in FIGS. 7 through 9 may contain a large number of sub-regions, only a limited number of the sub-regions is shown in FIGS. 7 through 9 for clarity. Each sub-region may contain different diffractive structures, such as gratings, lenses, and their combinations.

FIG. 7 presents a schematic layout of the out-coupling region 701 of the waveguiding component containing multiple rectangular-shaped diffractive sub-regions 702. The out-coupling sub-regions 702 arranged in columns with separation gaps between the columns. The out-coupling sub-regions 702 in FIG. 7 are composed of different diffractive gratings 703. Diffraction gratings 703 within the individual out-coupling sub-regions 702 have different line spacings and different azimuthal orientations of the gratings' lines. Only a limited number of gratings 703 is shown in FIG. 7 for clarity.

FIG. 8 presents a schematic layout of the out-coupling region 801 containing several rectangular-shaped out-coupling sub-regions 802 arranged in a two-dimensional array of rows and columns. The out-coupling sub-regions 802 in FIG. 8 are composed of different diffractive lenses 803. Diffractive lenses 803 within the individual out-coupling sub-regions 802 may have different focal lengths and lateral offsets. Only a limited number of lenses 803 is shown in FIG. 8 for clarity.

FIG. 9 presents a schematic layout of the out-coupling region 901 containing several circular-shaped out-coupling sub-regions 902 arranged in a two-dimensional array, for which every other column of the out-coupling sub-regions is vertically offset by half the vertical spacing between the sub-regions. The out-coupling sub-regions 902 in FIG. 9 are composed of arrangements of sub-wavelength structures 903, also known as meta-atoms, such as pillars, holes or fins with different sizes, azimuthal orientations, and shapes. The nano-structure arrangements 903 within the individual out-coupling sub-regions 902 form different gratings, lenses, beam-splitters, and their combinations. Only a limited number of nano-structures 903 is shown in FIG. 9 for clarity.

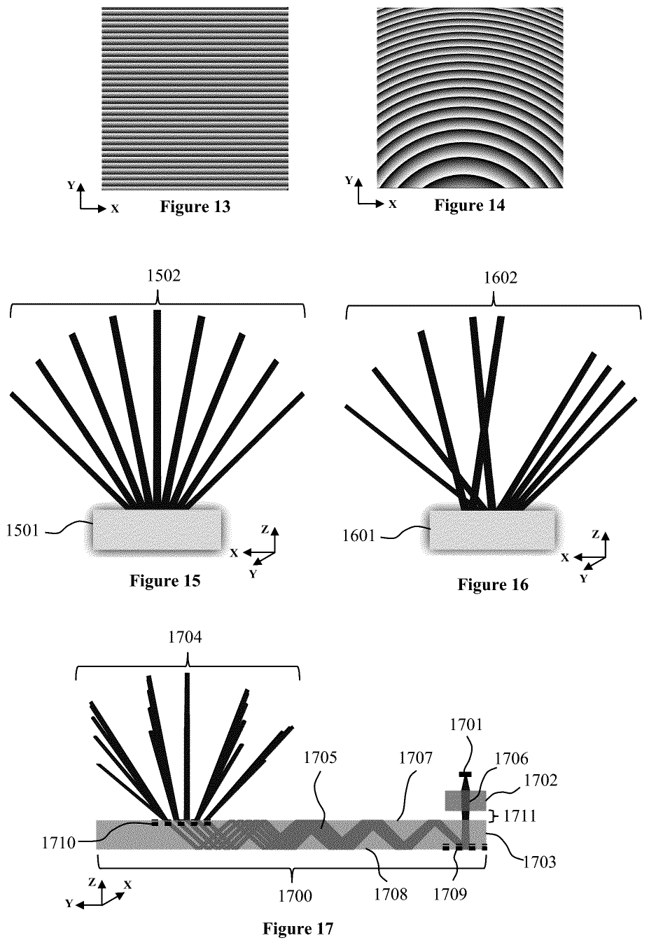

FIG. 10 presents the spatial phase distribution of a diffractive lens with square aperture centered to the square-shaped out-coupling sub-region. FIG. 11 schematically presents the spatial phase distribution of a diffraction grating with square aperture located within the square-shaped out-coupling sub-region. The lens and grating functions can be combined in a single diffractive structure, resulting in a diffractive lens phase distribution that is offset from the out-coupling sub-region center, as shown in FIG. 12. FIG. 13 presents spatial phase distribution of another diffraction grating placed within the square-shaped out-coupling sub-region. The grating in FIG. 13 has smaller grating line spacing as compared with the grating in FIG. 11, and therefore has a stronger diffractive properties. The lens phase in FIG. 10 and the grating phase in FIG. 13 can be combined, resulting in a phase distribution over the square-shaped out-coupling sub-region shown in FIG. 14. The phase distribution in FIG. 14 defines lens structure that is offset from the center of the out-coupling sub-region. The offset value in FIG. 14 is larger compared to the offset shown in FIG. 12, with the lens center in FIG. 14 no longer positioned within the boundaries of the out-coupling sub-region.

In the case of the waveguide-based light emitting module of the present invention, a large number of out-coupling sub-regions can be employed, each subregion dedicated to efficient light out-coupling. The number of out-coupling sub-regions can be in excess of several thousand or more. The area occupied by the out-coupling sub-regions of the light emitting module serves as an output aperture of the module and is significantly larger than the out-coupling region of the near-eye display. Efficiency of the out-coupled light from the light emitting module is relatively high, as most of the out-coupled light from the different sub-regions is intended to be out-coupled through a limited number of interactions with the out-coupling sub-regions. The lateral placement of the out-coupling sub-regions of the light emitting module with respect to the in-coupling region and their diffractive properties are defined based on the specific requirements for the light out-coupled directions.

### Illustrative Example

The light emitting module of the first embodiment shown in FIG. 1 is designed to operate at the wavelength of λ=0.94 μm. The module collimating lens has a clear aperture of 0.25 mm and is made as a monolithic block of fused silica with a nominal thickness of 0.70 mm placed in proximity to the in-coupling region of the waveguide. The back working distance of the collimating lens that defines the axial separation between the back surface of the lens and the emitter array is 0.55 mm. The diffractive optical power of the lens is defined by the lens phase polynomial Φ:

$$Φ = {A}_{1} {ρ}^{2} + {A}_{2} {ρ}^{4} + {A}_{3} {ρ}^{6} + {A}_{4} {ρ}^{8} \qquad ( 2 )$$

where ρ is the radial coordinate, and A₁, A₂, A₃ and A₄ are the radial phase coefficients of the lens diffractive surface, as defined in Table 1 below.

TABLE 1
Coefficients of the diffractive collimating lens

| Parameter | A₁ | A₂ | A₃ | A₄ |
|---|---|---|---|---|
| Value | −6002.4 | 175.6 | −992.4 | 1788.3 |

The waveguiding component is made of fused silica with refractive index 1.4512 and thickness of 1.0 mm. The in-coupling region is made as a grating structure working in the 1^{st} diffraction order, with the grating's nominal line spacing prescribed to be 862 nm. The grating lines are oriented normal to the light propagation direction within the waveguide.

As an example of a light emitting module in accordance with the present invention, we present the out-coupling grating parameters for 45 out-coupling sub-regions of a waveguiding component. The gratings are working in the first diffraction order m=1 at the operating wavelength λ=940 nm. Each grating structure is designed to produce 9 TIRs within the waveguide before reaching the center of the out-coupling structure.

Parameters of the gratings within the individual out-coupling sub-regions and the associated output light beam directions are listed in Table 2.

TABLE 2
Parameters of the out-coupling gratings regions

| Out- | Out-coupled | Out-coupled | Grating's | Grating's |
|---|---|---|---|---|
| coupling | beams X-axis | beams Y-axis | line | azimuthal |
| sub-region's | directional | directional | spacing dⱼ | orientation |
| number j | component Sᵢₓ | component S_{iy} | (μ) | φ_{g} (deg.) |
| 1 | 0 | 0 | 0.862 | 0.0 |
| 2 | 0.174 | 0 | 0.851 | 9.0 |
| 3 | 0.342 | 0 | 0.823 | 17.4 |
| 4 | 0.500 | 0 | 0.784 | 24.6 |
| 5 | 0.643 | 0 | 0.743 | 30.5 |
| 6 | −0.174 | 0 | 0.851 | −9.0 |
| 7 | −0.342 | 0 | 0.823 | −17.4 |
| 8 | −0.5 | 0 | 0.784 | −24.6 |
| 9 | −0.643 | 0 | 0.743 | −30.5 |
| 10 | 0 | 0.174 | 1.025 | 0 |
| 11 | 0.174 | 0.174 | 1.007 | 10.7 |
| 12 | 0.342 | 0.174 | 0.961 | 20.4 |
| 12 | 0.500 | 0.174 | 0.900 | 28.6 |
| 14 | 0.643 | 0.174 | 0.840 | 35.0 |
| 15 | −0.174 | 0.174 | 1.007 | −10.7 |
| 16 | −0.342 | 0.174 | 0.961 | −20.4 |
| 17 | −0.5 | 0.174 | 0.900 | −28.6 |
| 18 | −0.643 | 0.174 | 0.840 | −35.0 |
| 19 | 0 | −0.342 | 0.656 | 0 |
| 20 | 0.174 | −0.342 | 0.651 | 6.9 |
| 21 | 0.342 | −0.342 | 0.638 | 13.4 |
| 22 | 0.500 | −0.342 | 0.620 | 19.2 |
| 23 | 0.643 | −0.342 | 0.599 | 24.2 |
| 24 | −0.174 | −0.342 | 0.651 | −6.9 |
| 25 | −0.342 | −0.342 | 0.638 | −13.4 |
| 26 | −0.5 | −0.342 | 0.620 | −19.2 |
| 27 | −0.643 | −0.342 | 0.599 | −24.2 |
| 28 | 0 | 0.500 | 1.592 | 0 |
| 29 | 0.174 | 0.500 | 1.527 | 16.4 |
| 30 | 0.342 | 0.500 | 1.378 | 30.1 |
| 31 | 0.500 | 0.500 | 1.215 | 40.3 |
| 32 | 0.643 | 0.500 | 1.077 | 47.4 |
| 33 | −0.174 | 0.500 | 1.527 | −16.4 |
| 34 | −0.342 | 0.500 | 1.378 | −30.1 |
| 35 | −0.5 | 0.500 | 1.215 | −40.3 |
| 36 | −0.643 | 0.500 | 1.077 | −47.4 |
| 37 | 0 | −0.643 | 0.542 | 0 |
| 38 | 0.174 | −0.621 | 0.547 | 5.8 |
| 39 | 0.342 | −0.567 | 0.555 | 11.7 |
| 40 | 0.500 | −0.507 | 0.561 | 17.4 |
| 41 | 0.643 | −0.455 | 0.562 | 22.6 |
| 42 | −0.174 | −0.621 | 0.547 | −5.8 |
| 43 | −0.342 | −0.567 | 0.555 | −11.7 |
| 44 | −0.500 | −0.507 | 0.561 | −17.4 |
| 45 | −0.643 | −0.455 | 0.562 | −22.6 |

FIG. 15 presents an illustrative side view of the light emitting module along the waveguide propagation direction in accordance with the presented example. It shows the waveguiding component 1501 with planar interfaces and the out-coupled light beams 1502 emitted as a fan into multiple directions from the out-coupling region of the waveguiding component 1501. The specific directions of the individual beams correspond to the out-coupling sub-regions 1 through 9 with the gratings' parameters listed in Table 2. The out-coupled directions of the beams shown in FIG. 15 are incrementally spaced at equal angular intervals.

The present invention provides significant flexibility in defining directions of the out-coupled beams by adjusting the properties of the diffractive structures of the individual out-coupling sub-regions. FIG. 16 presents a different side view example of the light emitting module in accordance with the present invention. It shows the waveguiding component 1601 with planar interfaces and light beams 1602 emitted into multiple directions from the out-coupling sub-regions of the waveguiding component 1601. The specific directions of the emitted beams 1602 correspond to the out-coupling sub-regions 1 through 9 with grating parameters listed in Table 3. The out-coupling directions of light beams in FIG. 16 are spaced at inequal angular intervals.

TABLE 3
Parameters of the out-coupling gratings' regions for the second example

| Out- | | | | Grating's |
|---|---|---|---|---|
| coupling | Out-coupled beams | Out-coupled beams | | azimuthal |
| sub-region's | X-axis directional | Y-axis directional | Grating's line | orientation |
| number j | component Sᵢₓ | component S_{iy} | spacing dⱼ (μ) | φ_{g} (deg.) |
| 1 | 0.1 | 0 | 0.862 | 5.3 |
| 2 | 0.6 | 0 | 0.755 | 28.8 |
| 3 | 0.75 | 0 | 0.710 | 34.5 |
| 4 | −0.2 | 0 | 0.848 | −10.4 |
| 5 | 0.17 | 0 | 0.852 | 8.9 |
| 6 | −0.5 | 0 | 0.784 | −24.6 |
| 7 | −0.55 | 0 | 0.770 | −26.8 |
| 8 | −0.6 | 0 | 0.755 | −28.8 |
| 9 | −0.65 | 0 | 0.740 | −30.8 |

FIG. 17 presents a side view of the second embodiment of the light emitting module in accordance with the present invention. The light emitting module 1700 contains an array of emitters 1701, a planar lens 1702, and a waveguiding component 1703 with planar interfaces defined by surfaces 1707 and 1708. The waveguiding component contains an in-coupling region 1709 fabricated on surface 1708 and an out-coupling region 1710 fabricated on surface 1707. The in-coupling region 1709 and the out-coupling region 1710 can incorporate different diffractive structures. FIG. 17 also shows the waveguided light 1705 within the waveguiding component 1703, and the output light beams 1704 emitted in multiple directions from the out-coupling region 1710. The lens 1702 and the waveguiding component 1703 have a spacing 1711 with a value of 300 microns. The rest of the optical parameters and prescription details of the second embodiment in FIG. 17 are the same as in the illustrative example of the first embodiment in FIG. 1.

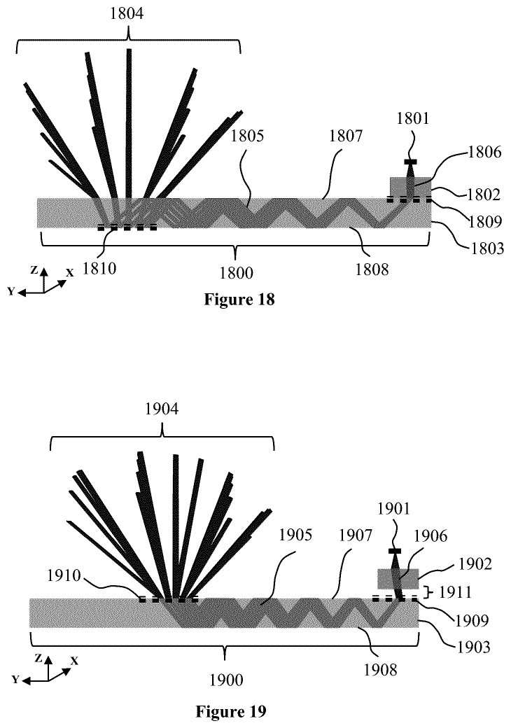

FIG. 18 presents a side view of the third embodiment of the light emitting module in accordance with the present invention. The light emitting module 1800 contains an array of emitters 1801, a planar lens 1802, and a waveguiding component 1803 with planar interfaces defined by surfaces 1807 and 1808. The lens 1802 and the waveguiding component 1803 are placed in proximity to each other. FIG. 18 also shows the waveguided light 1805 within the waveguiding component 1803, and the output light beams 1804 emitted in multiple directions from the out-coupling region 1810. The waveguiding component contains an in-coupling region 1809 fabricated on surface 1807 and an out-coupling region 1810 fabricated on surface 1808. The rest of the optical parameters and prescription details of the third embodiment in FIG. 18 are the same as in the illustrative example of the first embodiment in FIG. 1.

FIG. 19 presents a side view of the fourth embodiment of the light emitting module in accordance with the present invention. The light emitting module 1900 contains an array of emitters 1901, a planar lens 1902, and a waveguiding component 1903 with planar interfaces defined by surfaces 1907 and 1908. Emitter array 1901 is laterally offset pictorially in the y-dimension from the center of the lens 1902, resulting in angular tilt of the collimated light 1906. The offset can be a combination of both the x- and y-dimensions. The lens 1902 and the waveguiding component 1903 are spaced from each other. The waveguiding component 1903 contains an in-coupling region 1909 fabricated on surface 1907 and an out-coupling region 1910 fabricated on surface 1907. The in-coupling region 1909 and the out-coupling region 1910 can incorporate different diffractive structures. The collimated light 1906 is incident at an angle onto the in-coupling region 1909. FIG. 19 also shows the waveguided light 1905 within the waveguiding component 1903, and the output light beams 1904 emitted in multiple directions from the out-coupling region 1910. Emitter array 1901 and the lens 1902 are laterally offset from each other by 100 microns. The lens 1902 and the waveguiding component 1903 have a spacing 1911 with a value of 300 microns. The rest of the optical parameters and prescription details of the fourth embodiment in FIG. 19 are the same as those in the illustrative example of the first embodiment in FIG. 1.

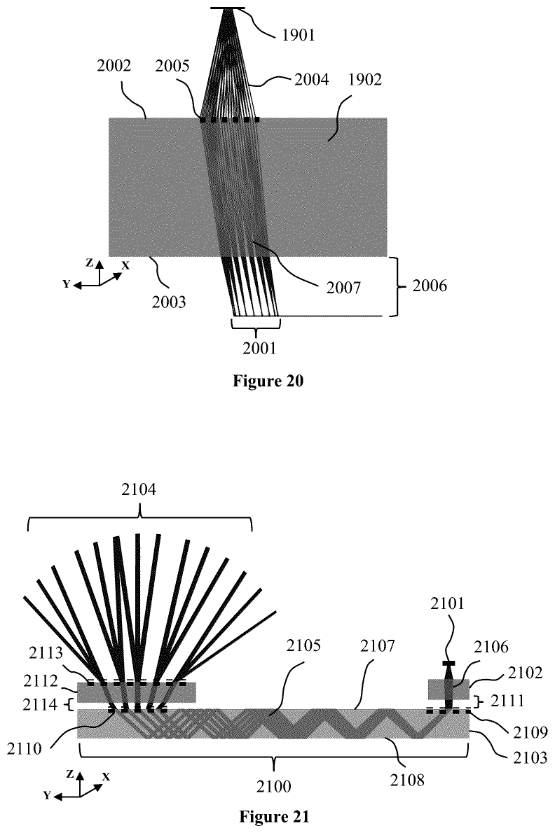

FIG. 20 shows light propagation details from an array of emitters 1901 through the lens 1902 onto the lens exit aperture 2001. The lens 1902 consists of a block of an optical material transparent within the spectral region of the waveguide-based light emitter, such as optical glass, silicon, or fused silica. The lens 1902 has two plane parallel optical surfaces 2002 and 2003. Alternative lens designs may contain diffractive regions fabricated on both lens surfaces 2002 and 2003, or solely on one of the lens surfaces. Lens 1902 shown in FIG. 20 has a single diffractive structure 2005 placed on surface 2002 facing the emitter array 1901. In addition to light collimation, diffractive region 2005 is designed to steer the light centroid at an angle with respect to the lens surfaces 2002 and 2003. Diffractive structure 2005 has a phase profile with center offset, similar to that shown in FIG. 12 or 14. Emitted diverging light 2004 from the array of emitters 1901 is collimated by the diffractive structure 2005 and is directed as a bundle 2007 at an angle to the surface 2002 onto the lens exit aperture 2001 located after the lens surface 2003. The distance 2006 between the lens surface 2003 and the exit aperture 2001 is 300 microns. Diffractive region 2004 can be made as a diffractive phase structure, such as meta-surface, geometrical phase surface, volume hologram, multi-step binary surface, etc.

To reduce the beam sparsity of the output illumination it is desirable to increase the number of the output emitted light beams. That is achieved by the out-coupling sub-regions that may contain beam-splitting structures that produce several secondary output beams from each of the out-coupling sub-regions. Alternatively, the increase in the number of the output emitted light beams may be achieved by adding a beam splitting component placed over the out-coupling region. The beam-splitting component will produce several additional output beams from each of the out-coupled beams emerging from the out-coupling sub-regions.

FIG. 21 presents a side view of the fifth embodiment of the light emitting module in accordance with the present invention. The light emitting module 2100 contains an array of emitters 2101, a planar lens 2102, and a waveguiding component 2103 with planar interfaces defined by surfaces 2107 and 2108. The lens 2102 and the waveguiding component 2103 are spaced apart from each other by a spacing 2111. The waveguiding component 2103 contains an in-coupling region 2109 fabricated on surface 2107 and an out-coupling region 2110 fabricated on surface 2107. The in-coupling region 2109 and the out-coupling region 2110 can incorporate different diffractive structures. Emitter array 2101 is centered with respect to the lens 2102, resulting in normal incidence of the collimated light 2106 onto the in-coupling region 2109 of the waveguiding component 2103. FIG. 21 also shows the waveguided light 2105 within the waveguiding component 2103. An additional component 2112 incorporating diffractive beam-splitting structure 2113 is placed above the out-coupling region 2110. The beam-splitting structure 2112 and the out-coupling region 2110 of the waveguiding component 2103 are spaced from each other by a spacing 2114. The light beams out-coupled from the region 2110 are directed onto the beam-splitting structure 2113 of the beam-splitting component 2112. Each of the out-coupled beams from region 2110 is split into several beams propagating at different directions, as shown in FIG. 21. The output beams 2104 after the beamsplitter 2112 may have equal or different intensities. The lens 2102 and the waveguiding component 2103 are spaced from each other by 300 microns. The beam-splitting component 2112 and the waveguiding component 2103 are spaced from each other by 200 microns. The beam-splitting component 2112 is made of fused silica with refractive index 1.4512 and thickness of 0.7 mm. The beam-splitting region is made as a periodic diffractive structure working in the −1^{st}, 0^{th}, and 1^{st} diffraction orders, with a period of 6.5 microns. The rest of the optical parameters and prescription details of the fifth embodiment in FIG. 21 are the same as those in the illustrative example of the first embodiment in FIG. 1.

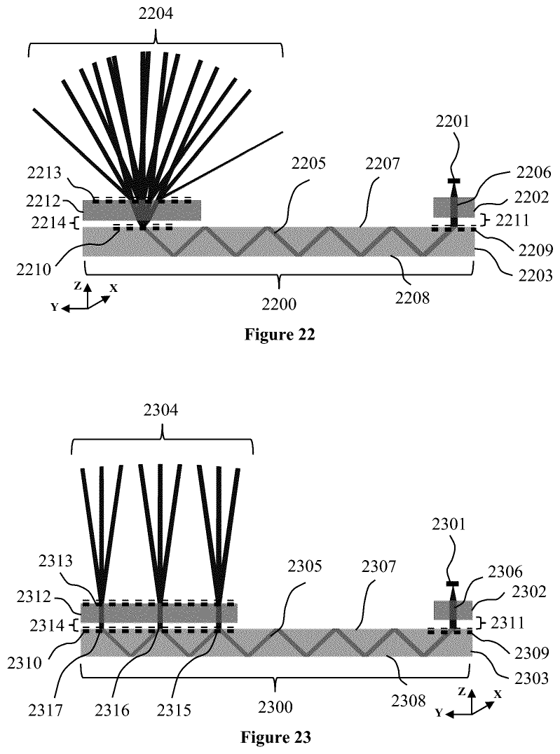

FIG. 22 presents a side view of the sixth embodiment of the light emitting module in accordance with the present invention. The light emitting module 2200 contains a single emitter 2201, a planar lens 2202, a waveguiding component 2203 with planar interfaces defined by surfaces 2207 and 2208, and a beam-splitting component 2212 containing beam-splitting diffraction grating 2213. The lens 2202 is spaced from the waveguiding component 2203 by a spacing 2211. The beam-splitting component 2212 is spaced from the waveguiding component 2203 by a spacing 2114. The waveguiding component 2203 contains an in-coupling region 2209 fabricated on surface 2207 and an out-coupling region 2210 fabricated on surface 2207. Emitter 2201 is centered with respect to the lens 2202, resulting in normal incidence of the collimated light 2206 onto the in-coupling region 2209 of the waveguiding component 2203. FIG. 22 also shows the waveguided light 2205 within the waveguiding component 2203. The out-coupling region 2210 is made as a beam-splitting component. The collimated light 2205 is out-coupled by diffractive out-coupler 2210 in the form of multiple secondary beams directed onto the beam-splitter 2212 at different angles. Each of the secondary beams out-coupled from the region 2210 is split by the beam-splitting surface 2213 into several beams that propagate in different directions, and result in the array of output beams 2204, as shown in FIG. 22. The output beams 2204 at the output of the beamsplitter 2213 may have equal or different intensities. The lens 2202 and the waveguiding component 2203 are spaced from each other by 300 microns. The beam-splitting component 2212 and the waveguiding component 2203 are spaced from each other by 200 microns. The beam-splitting component 2212 is made of fused silica with refractive index 1.4512 and thickness of 0.7 mm. The beam-splitting region 2210 of the waveguiding component 2203 is made as a periodic diffractive structure with the period of 0.86 microns that splits the out-coupled beam into 5 secondary beams diffracted into orders −2^{nd}, −1^{st}, 0^{th}, 1^{st}, and 2^{nd}. The beam-splitting region of the beam-splitting component 2212 is made as a periodic diffractive structure with the period of 4.0 microns that diffracts each of the incoming beams into the −1^{st}, 0^{th} and 1^{st} diffraction orders. The rest of the optical parameters and prescription details of the sixth embodiment in FIG. 22 are the same as those in the illustrative example of the first embodiment in FIG. 1.

FIG. 23 presents a side view of the seventh embodiment of the light emitting module in accordance with the present invention. The light emitting module 2300 contains a single emitter 2301, a planar lens 2302, a waveguiding component 2303 with planar interfaces defined by surfaces 2307 and 2308, and a beam-splitting component 2312 containing beam-splitting diffraction grating 2313. The lens 2302 is spaced from the waveguiding component 2203 by a spacing 2311. The beam-splitting component 2312 is spaced from the waveguiding component 2203 by a spacing 2314.. The waveguiding component 2303 contains an in-coupling region 2309 fabricated on surface 2307 and an out-coupling region 2310 fabricated on surface 2307. Emitter 2301 is centered with respect to the lens 2302, resulting in normal incidence of the collimated light 2306 onto the in-coupling region 2309 of the waveguiding component 2303. FIG. 23 also shows the waveguided light 2305 within the waveguiding component 2303. When the waveguided collimated light 2305 reaches the out-coupling region 2310 in the area 2314, only a fraction of light is out-coupled and directed towards the beam-splitting region 2313 of the beam splitter 2312. The rest of the collimated light continues to propagate within the waveguide 2303 experiencing total internal reflection. The waveguided light has multiple intersections with the out-coupling region 2310. FIG. 23 shows three intersections with the out-coupling region 2310 denoted as 2315, 2316, and 2317. Diffractive properties of the out-coupling region 2310 in the areas of the intersections 2315 through 2317 can be the same across the entire region, or can change across the out-coupling region 2310. The out-coupling region 2310 can also be composed of several out-coupling sub-regions with different diffractive properties in the areas of the intersections 2315 through 2317.

The collimated light 2305 out-coupled from the regions 2315, 2316, and 2317 of the diffractive out-coupling region 2310 is directed onto the beam-splitting diffractive region 2313 of the beam-splitter 2312. Each of the collimated beams out-coupled from the region 2310 is split by the beam-splitting surface 2312 into several secondary beams propagating in different directions, and resulting in an array of output beams 2304, as shown in FIG. 23. The output beams 2304 after the beamsplitter 2313 may have equal or different intensities.

The lens 2302 and the waveguiding component 2303 are spaced from each other by 300 microns. The beam-splitting component 2312 and the waveguiding component 2303 are spaced from each other by 200 microns. The beam-splitting component 2312 is made of fused silica with refractive index 1.4512 and thickness of 0.7 mm. The out-coupling region 2310 of the waveguiding component 2303 is made as a homogeneous periodic diffractive grating with the period of 862 nanometers. The beam-splitting region of the beam-splitting component 2312 is made as a periodic diffractive structure working in the −1^{st}, 0^{th} and 1^{st} diffraction orders, with the period of 6.5 microns. The rest of the optical parameters and prescription details of the seventh embodiment in FIG. 23 are the same as those in the illustrative example of the first embodiment in FIG. 1.

To improve homogeneity of the output light and reduce the appearance of dark regions, diffractive beam-splitting elements can be replaced with light diffusers that spread the incident beams over an angular range defined by the diffuser designs. Alternatively, the light emitting module of the present invention may contain an actuation mechanism for position adjustment of emitters with respect to the collimating lens. The actuation mechanism may perform one-dimensional and two-dimensional lateral positional adjustments of the emitters or the diffractive lens. It may also perform axial positional adjustments between emitters and the lens to adjust divergence of the waveguided light. A number of actuation mechanisms can be employed, including micro-electro-mechanical systems (MEMS) actuators and voice-coil actuators (VCAs). Based on the emitter array or the lens actuation, the out-coupled light beams will adjust their angular directions and divergence, sequentially covering broader angular space.

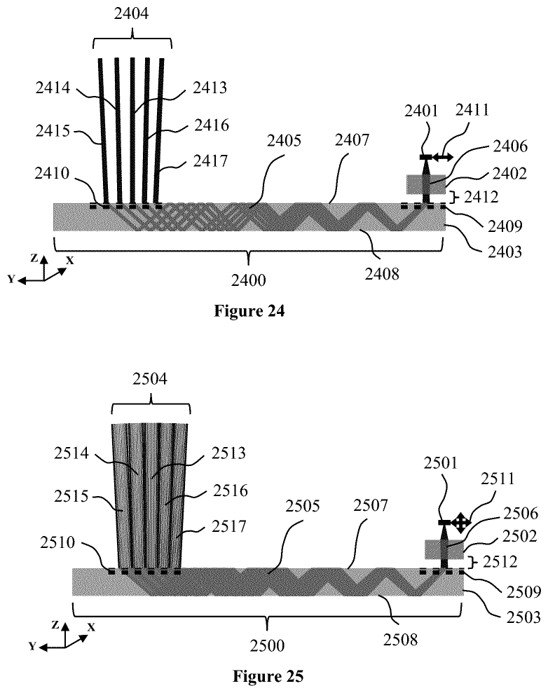

FIG. 24 presents a side view of the eighth embodiment of the light emitting module in accordance with the present invention. The light emitting module 2400 contains a single emitter 2401, a planar lens 2402, a waveguiding component 2403 with planar interfaces defined by surfaces 2407 and 2408. The axial spacing between emitter 2401 and the lens 2402 is 0.55 microns, corresponding to the collimated light at the output of the lens 2402. The light emitting module 2400 also contains an actuation mechanism 2411 for lateral adjustment of the emitter 2401 with respect to the lens 2402. The lens 2402 is spaced from the waveguiding component 2403 by a spacing 2412. The waveguiding component 2403 contains an in-coupling region 2409 fabricated on surface 2407 and an out-coupling region 2410 fabricated on surface 2407. FIG. 24 also shows the waveguided light 2405 within the waveguiding component 2403. When the actuation mechanism 2411 adjusts lateral position of the emitter 2401 relative to the lens 2402, that results in changes to the angle of incidence of the collimated light 2406 onto the in-coupling region 2409. Changes in the angle of incidence will lead to the corresponding changes in the in-coupled angle into the waveguide 2403. When the waveguided collimated light 2405 reaches the out-coupling region 2410, it is out-coupled as one of the output beams 2404. FIG. 24 shows five out-coupled beams 2413, 2414, 2415, 2416, and 2417 corresponding to five relative lateral displacements of the emitter 2401 with respect to the lens 2402. In the specific example shown in FIG. 24, the lateral displacements between emitter 2401 and the lens 2402 were adjusted by the actuator 2411 in increments of 12 micrometers. Similar effects can be observed when actuation of the lens 2402 is performed, rather than actuation of the light emitting module 2401. Distance between the light emitter 2401 and the lens 2402 was 0.55 microns, corresponding to a collimated light incident onto the in-coupling region 2410. The lens 2402 and the waveguiding component 2403 are spaced from each other by 300 microns. In the example shown in FIG. 24 the out-coupling region 2410 of the waveguiding component 2403 is made as a homogeneous periodic diffractive grating with the period of 862 nanometers across the entire out-coupling region. The out-coupling region 2410 can also be made to change its diffraction properties across the out-coupling area. For example, it can be made composed of several out-coupling sub-regions with different diffractive properties in the areas of the intersections of the out-coupled beams 2413 through 2417 with the out-coupling region 2410. The rest of the optical parameters and prescription details of the eighth embodiment in FIG. 24 are the same as those in the illustrative example of the first embodiment in FIG. 1.

FIG. 25 presents a side view of the ninth embodiment of the light emitting module 2500 in accordance to the present invention. The light emitting module 2500 contains a single emitter 2501, a planar lens 2502, a waveguiding component 2503 with planar interfaces defined by surfaces 2507 and 2508. The light emitting module 2500 also contains an actuation mechanism 2511 capable of both the lateral and axial adjustments of the emitter 2501 with respect to the lens 2502. The lens 2502 is spaced from the waveguiding component 2503 by a spacing 2512. The waveguiding component 2503 contains an in-coupling region 2509 fabricated on surface 2507 and an out-coupling region 2510 fabricated on surface 2507. FIG. 25 also shows the waveguided light 2505 within the waveguiding component 2503. Adjustments of the relative lateral position of the emitter 2501 with respect to the lens 2502 by the actuation mechanism 2511 will result in changes to the incident angle of light 2506 onto the in-coupling region 2509. Changes in the angle of incidence will lead to the corresponding changes in the in-coupled angle into the waveguide 2503. Adjustments in the axial position between the emitter 2501 and the lens 2502 will result in divergence angle changes of the emitter light 2506 incident onto the in-coupling region 2509. FIG. 25 illustrates the case when the axial distance between emitter 2501 and the lens 2502 is 0.53 microns, corresponding to the reduction by 20 microns to from the collimated value of 0.55 microns. When the diverging in-coupled light 2505 reaches the out-coupling region 2510, it is out-coupled as one of the output beams 2504. FIG. 25 shows five out-coupled beams 2513, 2514, 2515, 2516, and 2517 corresponding to five relative lateral displacements of the emitter 2501 with respect to the lens 2502. In the specific example shown in FIG. 25, the lateral displacements between emitter 2501 and the lens 2502 were adjusted by the actuator 2511 in increments of 12 micrometers. Similar changes in the out-coupling beam 2504 can be observed when actuation of the lens 2502 is performed, rather than actuation of the light emitting module 2501. The lens 2502 and the waveguiding component 2503 are spaced from each other by 300 microns. In the example shown in FIG. 25 the out-coupling region 2510 of the waveguiding component 2503 is made as a homogeneous periodic diffraction grating with the period of 862 nanometers across the entire out-coupling region. The out-coupling region 2510 can also be made to change its diffraction properties across the out-coupling area. For example, it can be made composed of several out-coupling sub-regions with different diffractive properties in the areas of the intersections of the out-coupled beams 2513 through 2517 with the out-coupling region 2510. The out-coupling region 2510 can be also made with diffractive properties continuously changing across the region. For example, the grating ridge spacing, width and height can be gradually adjusted. When the region 2510 is made composed of sub-wavelength meta-atoms, the meta-atoms' properties, such as their spacing, shape and size can be adjusted across the out-coupling area 2510. The rest of the optical parameters and prescription details of the nineth embodiment in FIG. 25 are the same as in the illustrative example of the first embodiment in FIG. 1.

Implementation details of the waveguide-based light emitting module in accordance with the present invention provide specific design examples of the system. It is understood that numerous other examples of light emitting modules can be constructed by those skilled in the art based on the provided description and associated details, and using different output light beams directions, operating wavelengths, waveguide geometries, and materials.

### REFERENCES

1. U.S. Pat. No. 11,456,326 “Plenoptic camera for mobile devices”, issued Sep. 27, 2022.
2. U.S. Pat. No. 11,115,573 “Hyperspectral plenoptic camera”, issued Sep. 7, 2021.
3. U.S. Pat. No. 8,290,358 “Methods and apparatus for light-field imaging”, issued Oct. 16, 2012.
4. Y. Soskind, “Field Guide to Diffractive Optics”, SPIE Press, 2011, page 51.
5. U.S. Pat. No. 9,372,347 “Display System”, issued Jun. 21, 2016.
6. U.S. Pat. No. 10,838,110 “Metasurface Optical Coupling Elements for a Display Waveguide”, issued Nov. 17, 2020.
7. G. Wetzstein, et. al., “On plenoptic multiplexing and reconstruction.” International journal of computer vision 101 (2013): 384-400.
8. R. Ng, et. al., Light field photography with a hand-held plenoptic camera. Tech. Report, CTSR 2005-02.

1. A waveguide-based light emitting module for producing multiple output light beams, the module comprising:
an assembly of light emitting sources;
an optical waveguiding component including diffractive in-coupling and out-coupling regions;
a lens positioned between the light emitting sources and the optical waveguiding component to collect light emitted by the light emitting sources and direct the light onto the diffractive waveguide in-coupling region;
wherein said diffractive out-coupling region of the waveguiding component includes a plurality of out-coupling sub-regions configured to direct a fraction of the out-coupled light into a plurality of specified angles, and
wherein relative positions of individual out-coupling sub-regions with respect to the diffractive in-coupling regions of the waveguiding component are arranged so that each of the individual out-coupling sub-regions intercept the light emitted by selected ones of the light emitting sources of the assembly of light emitting sources.

2. The waveguide-based light emitting module in accordance with claim 1, further comprising an actuation mechanism for lateral positional adjustment of the light emitting sources with respect to the lens.

3. The waveguide-based light emitting module in accordance with claim 1, further comprising an actuation mechanism for axial positional adjustment of the light emitting sources with respect to the lens.

4. The waveguide-based light emitting module in accordance with claim 1, wherein the output light is out-coupled from the out-coupling sub-regions to provide structured illumination patterns.

5. The waveguide-based light emitting module in accordance with claim 1, wherein the output light is out-coupled from the out-coupling sub-regions to provide homogeneously distributed illumination patterns.

6. The waveguide-based light emitting module in accordance with claim 1, wherein the lens is configured to reduce the divergence of light from the light emitting sources.

7. The waveguide-based light emitting module in accordance with claim 6, wherein the lens is further configured to collimate the light from the light emitting sources.

8. The waveguide-based light emitting module in accordance with claim 1, wherein the lens is configured to direct light from the light emitting sources at a skew angle with respect to the diffractive in-coupling region.

9. The waveguide-based light emitting module in accordance with claim 1, wherein at least one surface of the lens includes diffractive phase structures.

10. The waveguide-based light emitting module in accordance with claim 1, wherein the diffractive in-coupling region of the waveguiding component includes a diffractive phase structure.

11. The waveguide-based light emitting module in accordance with claim 1, wherein the out-coupling sub-regions of the diffractive out-coupling region includes a plurality of different types of diffractive structures.

12. The waveguide-based light emitting module in accordance with claim 11, wherein the out-coupling sub-regions include diffractive beam splitters.

13. The waveguide-based light emitting module in accordance with claim 1, wherein diffraction properties of individual out-coupling sub-regions are individually configured for out-coupling light from specific ones of the light emitting sources.

14. The waveguide-based light emitting module in accordance with claim 1, wherein a lateral size of the diffractive out-coupling region is larger than a lateral size of the diffractive in-coupling region.

15. The waveguide-based light emitting module in accordance with claim 1, further comprising a diffractive beam-splitting component located above the out-coupling sub-regions of the optical waveguiding component.

16. A method of producing light illumination patterns using a waveguiding component, comprising:
directing light from a plurality of a light emitters of an emitter assembly onto a light collecting lens;
directing the light onto a diffractive in-coupling region of the waveguiding component to thereby in-couple the light into the waveguiding component to undergo total internal reflections at planar interfaces of said waveguiding component;
directing the in-coupled light from said light emitters to propagate within the waveguiding component so that the in-coupled light emitted by the individual light emitters will be captured by specific out-coupling sub-regions of the waveguiding component;
out-coupling a fraction of light from said out-coupling sub-regions that has undergone total internal reflection within the waveguiding component; and
directing the out-coupled light into a plurality of specified angular directions.

17. A method of producing light illumination patterns in accordance with claim 16, wherein the light collecting lens performs collimation of the collected light.

18. A method of producing light illumination patterns in accordance with claim 16, further comprising laterally adjusting a relative position of the light emitter assembly with respect to the light collecting lens.

19. A method of producing light illumination patterns in accordance with claim 16, further comprising axially adjusting a relative distance of the light emitter assembly with respect to the light collecting lens.

20. A method of producing light illumination patterns in accordance with claim 16, further comprising splitting the out-coupled light into multiple beams propagating into different directions.
